(19) United States
(12) Patent Application Publication
(10) Pub. No.: US 2023/0114567 A1
(43) Pub. Date: Apr. 13, 2023

(54) MULTI-PIECE FASTENER INCLUDING A LOCKBOLT COLLAR ASSEMBLY AND METHOD OF FASTENING

(71) Applicant: Howmet Aerospace Inc., Pittsburgh, PA (US)

(72) Inventor: Robert B. Wilcox, McGregor, TX (US)

(21) Appl. No.: 17/907,289

(22) PCT Filed: Apr. 30, 2021
(86) PCT No.: PCT/US2021/030344

§ 371 Date: Sep. 26, 2022

Related U.S. Application Data
(60) Provisional application No. 63/018,687, filed on May 1, 2020.

(51) Int. Cl. F16B 19/05

(52) U.S. Cl. CPC F16B 19/05

(57) ABSTRACT

Non-limiting embodiments of a multi-piece fastener and a fastening method are disclosed. The multi-piece fastener comprises a fastening collar and a pin. The fastening collar comprises a first collar end, a second collar end, and an inner collar surface extending from the first collar end to the second collar end. The inner collar surface comprises a first lock region and defines a collar cavity. The pin is configured to be at least partially received by the collar cavity. The pin comprises a first pin end, a second pin end, and a shank extending intermediate the first pin end and the second pin end. The shank comprises a second lock region configured to engage the first lock region to form an interference fit between the fastening collar and the pin when the pin is received in the collar cavity. The fastening collar is configured to be deformed onto the shank.

### FIELD OF USE

The present disclosure relates to multi-piece fasteners and methods of fastening using a multi-piece fastener. More particularly, the present disclosure relates to a lockbolt collar assembly incorporating a locking taper and a related retention method.

### BACKGROUND

Various prior lockbolt collars assemblies do not include retention features, utilize a threaded type of retention, or include an elastomeric bead of material to retain a collar on the lockbolt prior to swaging. It is desirable to retain the collar on the lockbolt prior to swaging, but it can be time consuming to thread collars on the pin, and can be costly to head the tab in the collar or to apply a bead of elastomeric material.

### SUMMARY

One aspect according to the present disclosure is directed to a multi-piece fastener comprising a fastening collar and a pin. The fastening collar comprises a first collar end, a second collar end, and an inner collar surface extending from the first collar end to the second collar end. The inner collar surface comprises a first lock region and defines a collar cavity. The pin is configured to be at least partially received by the collar cavity. The pin comprises a first pin end, a second pin end, and a shank extending intermediate the first pin end and the second pin end. The shank comprises a second lock region configured to engage the first lock region of the fastening collar to form an interference fit between the fastening collar and the pin when the pin is received in the collar cavity. The fastening collar is configured to be deformed onto the shank to secure the fastening collar to the pin.

Another aspect according to the present disclosure is directed to a method for fastening using a multi-piece fastener. The method comprises inserting a first pin end of a multi-piece fastener into a bore in a structure. The multi-piece fastener comprises a fastening collar and a pin. The fastening collar comprises a first collar end, a second collar end, and an inner collar surface extending from the first collar end to the second collar end. The inner collar surface comprises a first lock region and defines a collar cavity. The pin is configured to be at least partially received by the collar cavity. The pin comprises the first pin end, a second pin end, and a shank extending intermediate the first pin end and the second pin end. The shank comprises a second lock region. At least a portion of the first pin end is passed into the collar cavity. The first lock region is forcibly contacted with the second lock region, thereby forming an interference fit between the fastening collar and the pin.

It will be understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples presented herein, and the manner of attaining them, will become more apparent, and the examples will be better understood, by reference to the following description taken in conjunction with the accompanying drawings, wherein:

FIG. 1 is a partial cross-sectional side elevational view showing aspects of a non-limiting embodiment of a multi-piece fastener according to the present disclosure;

FIG. 2 is a partial cross-sectional side elevational view showing aspects of a non-limiting embodiment of a multi-piece fastener according to the present disclosure;

FIG. 3A is a partial cross-sectional side elevational view of a non-limiting embodiment of a multi-piece fastener according to the present disclosure in a first position;

FIG. 3B is a partial cross-sectional side elevational view of the multi-piece fastener embodiment of FIG. 3A, shown with an interference fit formed between the fastening collar and the pin;

FIG. 3C is a partial cross-sectional side elevational view of the multi-piece fastener embodiment of FIG. 3B, shown after deformation of the fastening collar;

FIG. 4A is a partial cross-sectional side elevational view of a non-limiting embodiment of a multi-piece fastener according to the present disclosure, shown in a first position;

FIG. 4B is a partial cross-sectional side elevational view of the multi-piece fastener of FIG. 4A, shown with an interference fit formed between the fastening collar and the pin;

FIG. 4C is a partial cross-sectional side elevational view of the multi-piece fastener of FIG. 4B, shown after deformation of the fastening collar;

FIG. 5A is a partial cross-sectional side elevational view of a non-limiting embodiment of a multi-piece fastener according to the present disclosure, shown in a first position;

FIG. 5B is a partial cross-sectional side elevational view of the multi-piece fastener of FIG. 5A, shown with an interference fit formed between the fastening collar and the pin;

FIG. 5C is a partial cross-sectional side elevational view of the multi-piece fastener of FIG. 5B, shown after deformation of the fastening collar;

FIG. 6A is a partial cross-sectional side elevational view of a non-limiting embodiment of a multi-piece fastener according to the present disclosure, shown in a first position;

FIG. 6B is a partial cross-sectional side elevational view of the multi-piece fastener of FIG. 6A, shown with an interference fit formed between the fastening collar and the pin;

FIG. 6C is a partial cross-sectional side elevational view of the multi-piece fastener of FIG. 6B, shown after deformation of the fastening collar and fracturing of a breakneck groove;

FIG. 7A is a partial cross-sectional side elevational view of a non-limiting embodiment of a multi-piece fastener according to the present disclosure, shown in a first position;

FIG. 7B is a partial cross-sectional side elevational view of the multi-piece fastener of FIG. 7A, shown with an interference fit formed between the fastening collar and the pin;

FIG. 7C is a partial cross-sectional side elevational view of the multi-piece fastener of FIG. 7B, shown after deformation of the fastening collar and fracturing of a breakneck groove

FIG. 8A is a partial cross-sectional side elevational view of a non-limiting embodiment of a multi-piece fastener according to the present disclosure, shown in a first position;

FIG. 8B is a partial cross-sectional side elevational view of the multi-piece fastener of FIG. 8A, shown with an interference fit formed between the fastening collar and the pin;

FIG. 8C is a partial cross-sectional side elevational view of the multi-piece fastener of FIG. 8B, shown after deformation of the fastening collar and fracturing of a breakneck groove; and

FIG. 9 is a flow chart illustrating a non-limiting embodiment of a method for fastening according to the present disclosure.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION OF NON-LIMITING EMBODIMENTS

Various examples are described and illustrated herein to provide an overall understanding of the structure, function, and use of the disclosed multi-piece fasteners, fastening collars, and methods of fastening. The various examples described and illustrated herein are non-limiting and non-exhaustive. Thus, the invention is not limited by the description of the various non-limiting and non-exhaustive examples disclosed herein. Rather, the invention is defined solely by the claims. The features and characteristics illustrated and/or described in connection with various examples may be combined with the features and characteristics of other examples. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various embodiments,” “some embodiments,” “one embodiment,” “an embodiment,” or like phrases mean that a particular feature, structure, or characteristic described in connection with the example is included in at least one embodiment. Thus, appearances of the phrases “in various embodiments,” “in some embodiments,” “in one embodiment,” “in an embodiment,” or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

As used herein, “intermediate” means that the referenced element is disposed between two elements but is not necessarily in contact with those elements. Accordingly, unless stated otherwise herein, an element that is “intermediate” a first element and a second element may or may not be adjacent to or in contact with the first and/or second elements, and other elements may be disposed between the intermediate element and the first and/or second elements.

Installing multi-piece fasteners within a structure can involve several steps. Installing previously known lockbolt fasteners that comprise a threaded pin and a threaded fastening collar can require a step of threading (e.g., spinning) the threaded fastening collar onto the threaded pin prior to deforming the fastening collar onto the pin. While previous fasteners may suitably retain the threaded fastening collar on the pin by threading, forming corresponding threads on the fastening collars and pins during manufacture adds expense, and individually threading the fastening collars onto the pins can add significant time to the installation process. In other known lockbolt fasteners including an elastomeric material to retain the fastening collar to the pin during installation prior to deformation of the fastening collar, providing the elastomeric material on each multi-piece fastener can be inefficient and cost prohibitive.

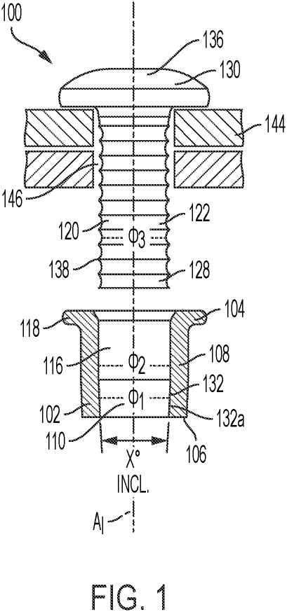

The present disclosure provide a multi-piece fastener configured to retain a fastening collar on a pin of the fastener prior to deformation of the fastening collar, without the requirement for corresponding threads or an elastomeric material. Embodiments of the multi-piece fastener of the present disclosure allow for retention of the fastening collar on the pin in an efficient manner that can simplify the installation process and may reduce the cost to produce the fasteners. FIG. 1 illustrates a non-limiting embodiment of a multi-piece fastener 100 according to the present disclosure. The multi-piece fastener 100 can be configured to be installed in a bore 146 in a structure 144. The multi-piece fastener 100 can comprise at least two components, such as, for example, a fastening collar 102 and a pin 120, as illustrated in FIG. 1. In other non-limiting embodiments (not shown), a multi-piece fastener according to the present disclosure can comprise three or more components. In various non-limiting embodiments, the multi-piece fastener 100 can consist of a two-piece assembly including the fastening collar 102 and the pin 120. In certain non-limiting embodiments, the multi-piece fastener 100 can comprise a lockbolt. For example, in certain non-limiting embodiment the lockbolt can be a structural lockbolt fastener, such as, for example, a structural rivet, a structural bolt, or a structural stud.

Again referring to FIG. 1, the fastening collar 102 of the multi-piece fastener 100 can comprise a first collar end 104, a second collar end 106, an elongate portion 108 disposed intermediate the first collar end 104 and the second collar end 106, and an inner collar surface 116. The elongate portion 108 can define a longitudinal axis, A₁, of the fastening collar 102 and/or the multi-piece fastener 100. In various non-limiting embodiments, the first collar end 104 can comprise a flange 118. The inner collar surface 116 extends from the first collar end 104 to the second collar end 106. The inner collar surface can define a collar cavity 110 that extends through the elongate portion 108, from the first collar end 104 to the second collar end 106. The inner collar surface 116 can comprise a first lock region 132.

The first lock region 132 of the inner collar surface 116 can be configured such that the fastening collar 102 is self-locking (e.g., friction locking) when urged onto the pin 120 by a force having at least a component along the longitudinal axis, A₁. For example, the first lock region 132 can comprise a taper that extends from the second collar end 102 along the longitudinal axis, A₁, into the collar cavity 110 such that a dimension (e.g., a diameter) of the collar cavity 110 decreases along the first lock region 132 in an axial direction towards the second collar end 106. For example, in various non-limiting embodiment the region of the inner collar surface 116 that forms the first lock region 132 can define a taper angle, X, no greater than 15 degrees relative to the longitudinal axis, A₁, such as, for example, no greater than 10 degrees, no greater than 9 degrees, no greater than 8 degrees, no greater than 7 degrees, or no greater than 6 degrees relative to the longitudinal axis A₁, whereby a diameter of the collar cavity 110 in the first lock region 132 gradually or incrementally decreases along a length of the first lock region 132. In various non-limiting embodiments, the region of the inner collar surface 116 that forms the first lock region 132 can define a taper angle, X, of at least 0.5 degrees relative to the longitudinal axis, A₁, such as, for example, at least 1 degree, at least 2 degrees, at least 5 degrees, at least 6 degrees, or at least 7 degrees. In certain non-limiting embodiments, the region of the inner collar surface 116 that forms the first lock region 132 can define a taper angle, X, in a range of 0.5 degrees to 15 degrees relative to the longitudinal axis, A₁, such as for example, in a range of 5 degrees to 10 degrees relative to the longitudinal axis, A₁ or in a range of 5 degrees to 7 degrees relative to the longitudinal axis, A₁. In various non-limiting embodiments, a diameter, φ₁, of the collar cavity 110 in the first lock region 132 is less than a diameter, φ₂, of the collar cavity 110 adjacent to the first lock region 132. In various non-limiting embodiments, the first lock region 132 can be substantially the same size as the bore 146.

In various non-limiting embodiments of the multi-piece fastener 100, the first lock region 132 of the collar cavity 110 can comprise a substantially flat taper. In various non-limiting embodiments of the multi-piece fastener 100, the region of the inner collar surface 116 that forms the first lock region 132 defines a frustoconical shape. In various non-limiting embodiments, the region of the inner collar surface 116 that forms the first lock region 132 can define a curve 132a relative to a longitudinal axis, A₁, of the fastening collar 132. In various embodiments, providing the foregoing surface contour on the inner collar surface 116 in the first lock region 132 of the collar cavity 110 can be less costly and/or complex than threading the same region of the collar cavity 110 or providing an elastomeric material in the multi-piece fastener.

Again referring to FIG. 1, the pin 120 of the multi-piece fastener 100 can comprise a first pin end 128, a second pin end 130, and a shank 122. The shank 122 can comprise a shape suitable to be received by the collar cavity 110 of the fastening collar 102. In various non-limiting embodiments, the shank 122 has a generally cylindrical shape. The shank 122 can extend intermediate the first pin end 128 and the second pin end 130 and can be dimensioned so that it can be inserted into and extend at least partially through the cavity 110. When the shank 122 is inserted in the cavity 110, the first pin end 128 can be disposed adjacent to the second collar end 106, and the second pin end 130 can be disposed adjacent to the first collar end 104. In various non-limiting embodiments, the pin 120 can further comprise a head portion 136 configured to inhibit the pin 120 from traversing through the bore 146 in the structure 144 beyond a predetermined distance. In various other non-limiting embodiments, the pin 120 may not comprise a head portion (not shown).

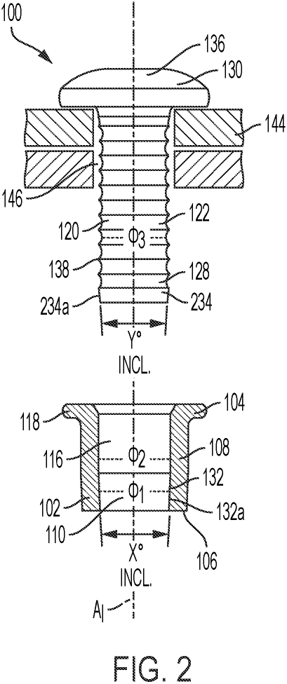

Referring to FIG. 2, the shank 122 can comprise a second lock region 134 configured to engage the first lock region 132 and form an interference fit between the fastening collar 102 and the pin 120 when the pin 120 is received in the collar cavity 110. In this way, the fastening collar 102 can be retained on the pin 120 during installation of the multi-piece fastener, prior to deformation of the fastening collar 102 on the pin 120. The second lock region 234 can be configured to compliment the first lock region 234 to facilitate forming a self-locking, interference fit when the fastening collar 102 is urged onto the pin 120 with a force at least partially directed along the longitudinal axis, A₁. For example, the second lock region 234 can comprise a taper that extends from the first pin end 128 along the longitudinal axis, A₁, such that a dimension of the shank 122 decreases along the second lock region 234 in an axial direction towards the first pin end 128. For example, the second lock region 234 can define a taper angle, Y, of no greater than 15 degrees relative to the longitudinal axis, A₁, such as, for example, no greater than 10 degrees, 9 degrees, no greater than 8 degrees, no greater than 7 degrees, or no greater than 6 degrees. In various non-limiting embodiments, the second lock region 234 can define a taper angle, Y, of at least 0.5 degrees relative to the longitudinal axis, A₁, such as, for example, at least 1 degree, at least 2 degrees, at least 5 degrees, at least 6 degrees, or at least 7 degrees. In certain non-limiting embodiments, the second lock region 234 can define a taper angle, Y, in a range of 0.5 degrees to 15 degrees relative to the longitudinal axis, A₁, such as for example, in a range of 5 degrees to 10 degrees relative to the longitudinal axis, A₁, or in a range of 5 degrees to 7 degrees relative to the longitudinal axis, A₁. In various non-limiting embodiments, a diameter of the shank 122 decreases along the second lock region 234 in an axial direction towards the first pin end 128.

In various non-limiting embodiment of the multi-piece fastener 100, the second lock region 234 of the pin 120 can comprise a substantially flat taper. In various non-limiting embodiments of the multi-piece fastener 100, the second lock region 234 can comprise a frustoconical shape. In various non-limiting embodiments, the second lock region 234 can define a curve 234a relative to a longitudinal axis, A₁, of the pin 122. In various non-limiting embodiments, the second lock region 234 can be substantially cylindrical (not shown).

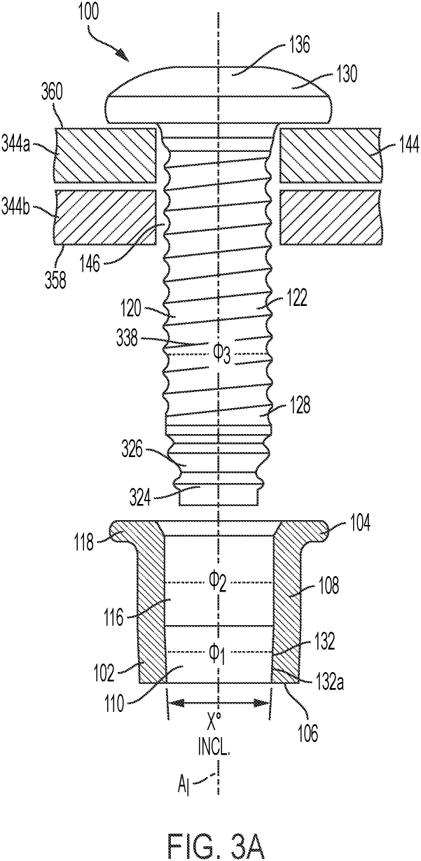

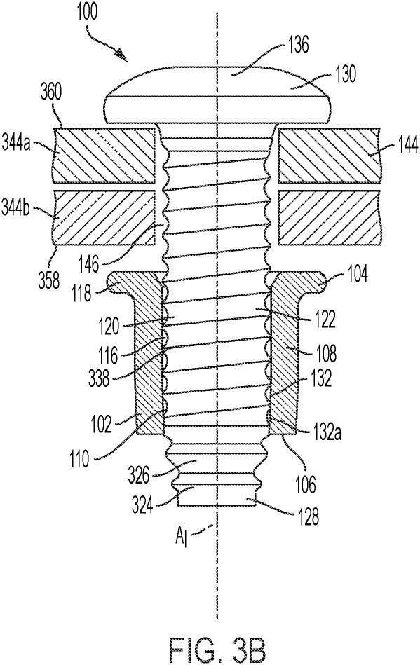

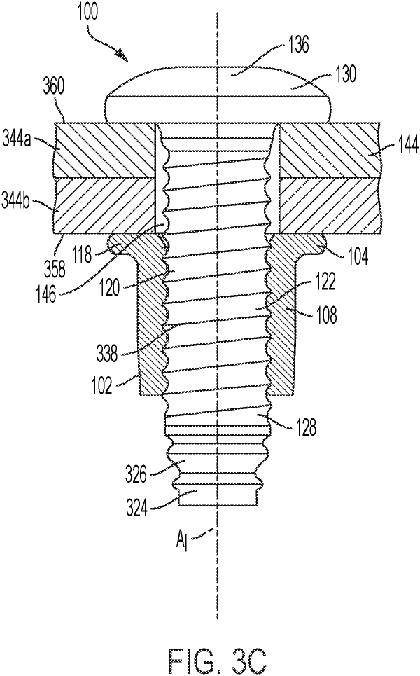

Referring to FIGS. 3A-C, in various non-limiting embodiments of the multi-piece fastener according to the present disclosure, the first pin end 128 can comprise a pull region 324 configured to be engaged by a multi-piece fastener installation tool (not shown) when installing the multi-piece fastener 100 in a bore in a structure. The pull region 324 can comprise an axial length, and in various non-limiting embodiments the pull region 324 can comprise a taper. In various embodiments, the pull region 324 can comprise at least one of a generally smooth region, an annular shoulder, a groove, and a bore and/or can comprise one or more other features configured to be engaged by a multi-piece fastener installation tool. For example, and without limitation, the pull region 324 can comprise grooves 326, as illustrated in FIGS. 3A-C, that can be engaged by a multi-piece fastener installation tool. In certain non-limiting embodiments, the multi-piece fastener installation tool can be a puller tool or a squeezer tool.

Referring again to FIG. 1, the shank 122 of the pin 120 can define the longitudinal axis, A₁, of the pin 120 and/or the multi-piece fastener 100. The shank 122 can be configured to engage the fastening collar 102 in order to retain the shank 122 to the fastening collar 102. Upon engagement between the shank 122 and the fastening collar 102, the longitudinal axis of the pin 120 and the longitudinal axis of the fastening collar 102 can be substantially aligned along a longitudinal axis, A₁, of the multi-piece fastener 100.

In various non-limiting embodiments, the shank 122 of the pin 120 can comprise one or more of a generally smooth region, a threaded region, an annular shoulder, and a groove that contact the inner collar surface 116 of the fastening collar 102. The threaded region, annular shoulder, and/or the groove can be external relative to the shank 122. In various non-limiting embodiments, all or a portion of the shank 122 includes grooves. For example, as shown in FIGS. 1, 2, 4A-C, 5A-C, 6A-C, 7A-C, and 8A-C, the shank 122 of the pin 120 includes grooves 138. In other non-limiting embodiments, all or a portion of the shank 122 lacks threads. In various non-limiting embodiments, all or a portion of the shank 122 includes an annular shoulder. In other non-limiting embodiments, the shank 122 lacks an annular shoulder. In various non-limiting embodiments, all or a portion of the shank 122 includes threads. For example, as shown in FIGS. 3A-C, the shank 122 of the pin 120 includes threads 338. In other non-limiting embodiments, the shank 122 lacks threads. Referring again to FIG. 1, in certain non-limiting embodiments, a diameter, φ₃, of the shank 122 is in a range of 0.06 inches to 4 inches.

The collar cavity 110 of the fastening collar 102 can be configured to at least partially receive the shank 122 of the pin 120 therein. For example, the collar cavity 110 can comprise a shape suitable to receive the shank 122 of the pin 120. The fastening collar 102 can be configured to be at least partially deformed onto the shank 122. For example, during and/or after introduction of the shank 122 into the collar cavity 110, the elongate portion 108, including at least a portion of surface 116, can be at least partially deformed (e.g., swaged) onto the shank 122 responsive to forcible contact between the fastening collar 102 and a multi-piece fastener installation tool. Deformation of the elongate portion 108 can secure the fastening collar 102 to the shank 122 of the pin 120, securing the multi-piece fastener within a bore of a structure.

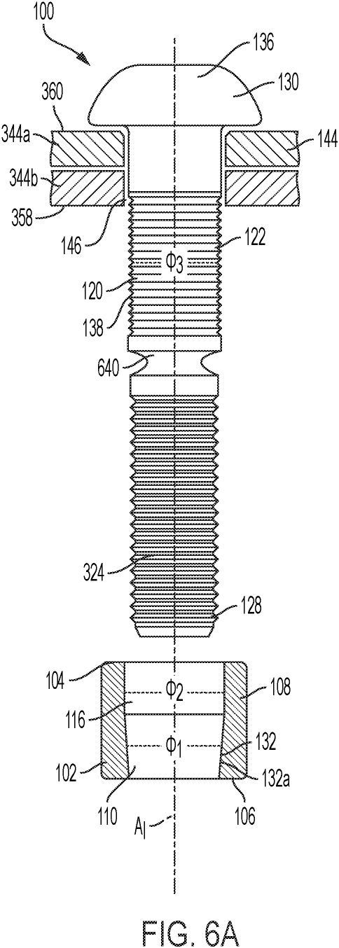

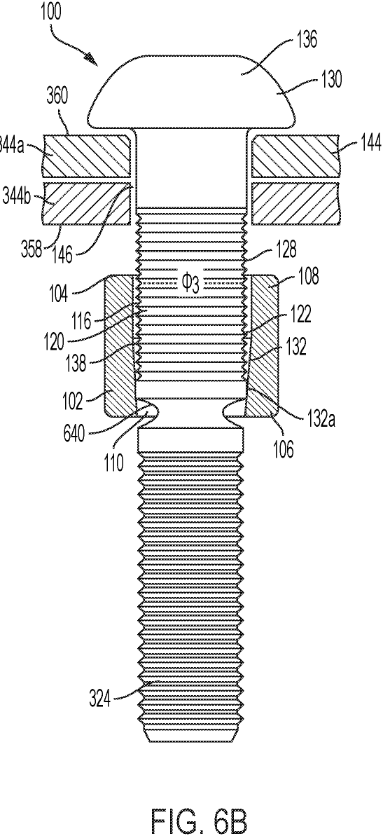

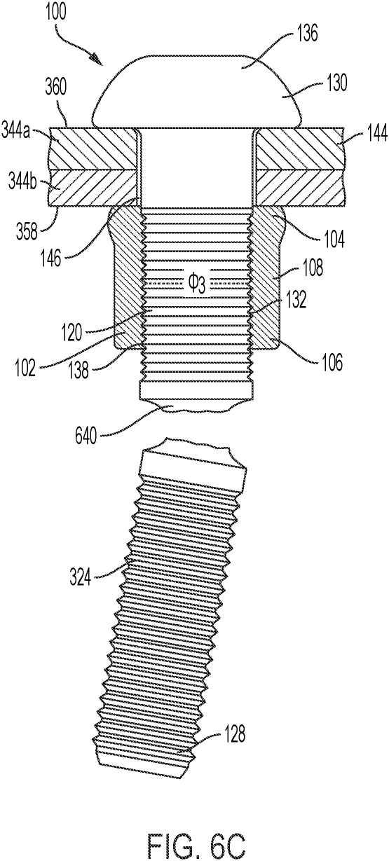

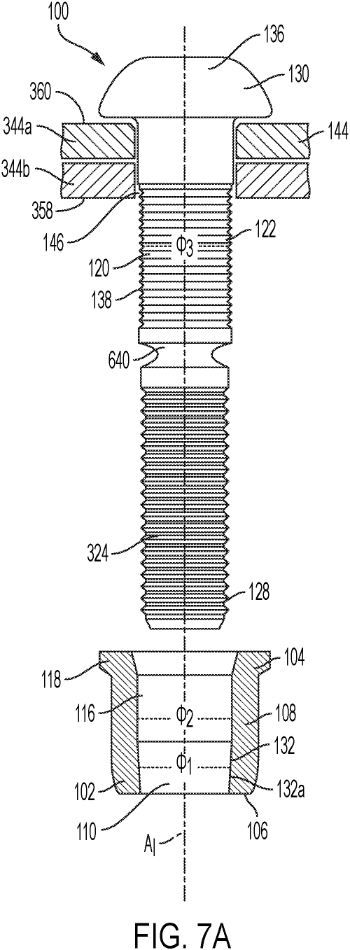

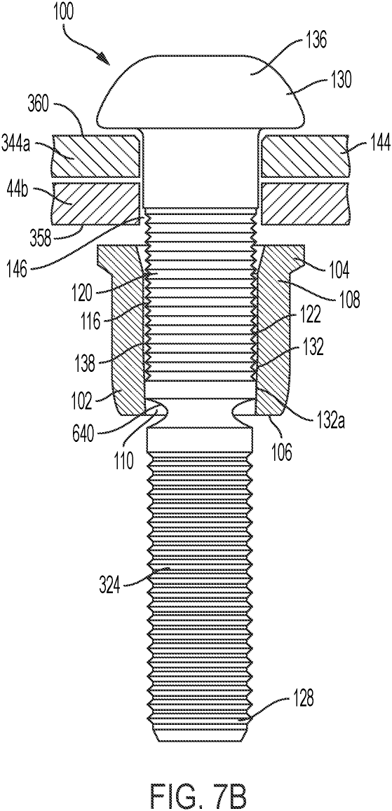

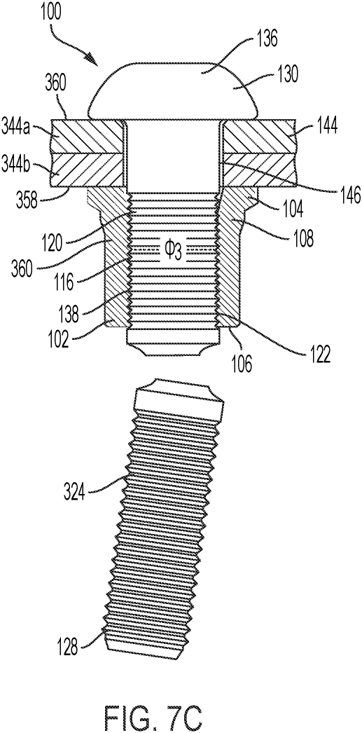

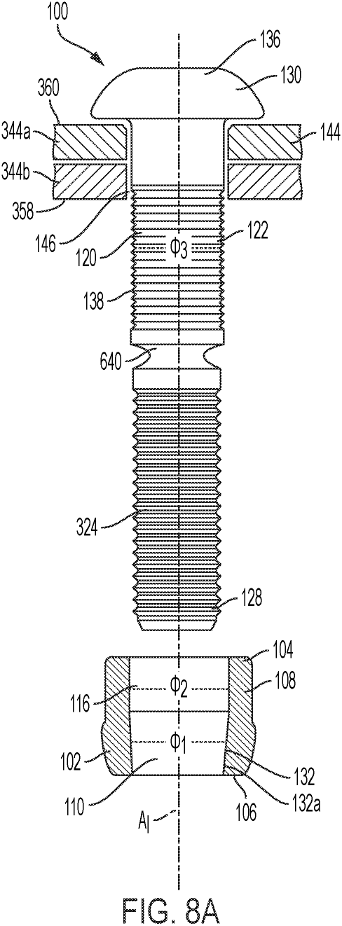

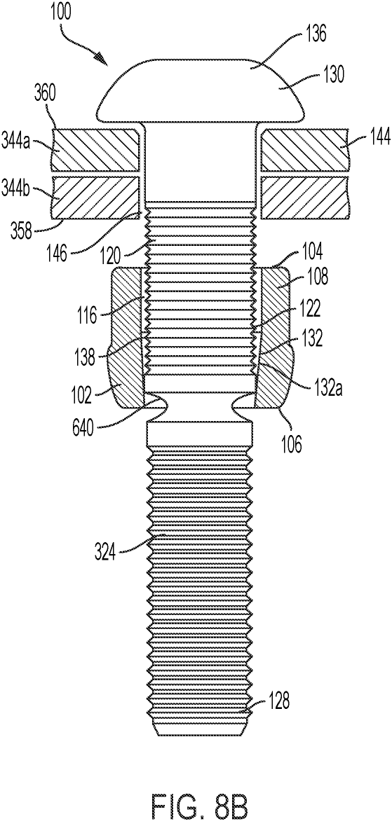

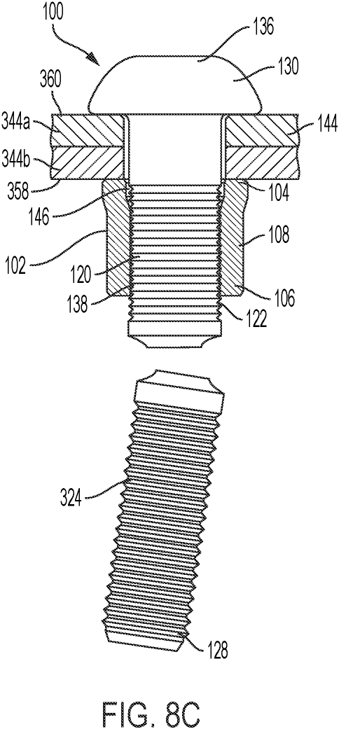

Referring to FIGS. 6A-6C, 7A-7C, and 8A-8C, for example, in various non-limiting embodiments the pin 120 may comprise a breakneck groove 640 configured to fracture upon installation of the multi-piece fastener in a structure. In certain other non-limiting embodiments, the pin 120 does not comprise a breakneck groove but is configured to include one or more other features so that a pull region 324 of the pin 120 fractures during installation of the multi-piece fastener 100. Referring to FIGS. 3A-3C, for example, in various non-limiting embodiments of the multi-piece fastener 100, the pin 120 does not comprise a breakneck groove or other feature configured to fracture upon installation of the multi-piece fastener 100, and the pull region 324 remains intact after installation. Thus, according to various non-limiting embodiments, multi-piece fasteners according to the present disclosure may be installed in a structure without fracturing of a breakneck groove or other feature, or the fasteners may include a breakneck groove or other feature that fractures upon installation of the fastener into the structure.

The multi-piece fastener 100 can comprise at least one of a metal, a metal alloy, a composite material, or another suitable material. For example, in various non-limiting embodiments, the multi-piece fastener 100 can comprise at least one of aluminum, an aluminum alloy, titanium, a titanium alloy, nickel, a nickel alloy, iron, an iron alloy, and a carbon fiber composite material.

As illustrated in FIGS. 3A-3C, the multi-piece fastener 100 can be installed into a bore 146 of a structure 144. As illustrated, the bore 146 can extend through the structure 144 from a first side 358 to a second side 360. The structure 144 can comprise, for example, at least one of a metal, a metal alloy, a composite material, or another suitable material. For example, in certain non-limiting embodiments, the structure 144 can comprise one or more of aluminum, an aluminum alloy, titanium, a titanium alloy, nickel, a nickel alloy, iron, an iron alloy, and a carbon fiber composite material. In various non-limiting embodiments, the structure 144 in which the multi-piece fastener 100 is installed comprises aluminum and/or an aluminum alloy, such as, for example, 7075 aluminum alloy. With reference to the accompanying figures, in various embodiments the structure 144 can be configured as at least one of an aerospace component or structure, an automotive component or structure, a transportation component or structure, a building and construction component or structure, or another component or structure.

The structure 144 can comprise a single layer of material or two or more layers of material. For example, as illustrated in FIGS. 3A-3C, the structure 144 can comprise a first layer 344a and a second layer 344b, which may be the same material or different materials. The first layer 344a can be positioned intermediate the second layer 344b and the fastening collar 102 when the multi-piece fastener 100 is installed. In various non-limiting embodiments, the first layer 344a is adjacent to the fastening collar 102.

Additionally, in various non-limiting embodiments, the first pin end 128 can be sized and configured to facilitate alignment of the pin 120 with the bore 146, thereby allowing the first pin end 128 to readily move into and through the bore 146. In various non-limiting embodiments, the head portion 136 can be sized and configured to inhibit the pin 120 from traversing into the bore 146 beyond a predetermined distance.

Various features of embodiments of multi-piece fasteners according to the present disclosure will now be described in connection with the accompanying figures.

As illustrated in FIG. 3A, the first pin end 128 of the pin 120 has been positioned in alignment with the second side 360 of the bore 146 and inserted through the bore 146, and the fastening collar 102 has been positioned over the first pin end 128.

Referring to FIG. 3B, the first pin end 128 has been inserted into the collar cavity 110 of the fastening collar 102 and the first locking region 132 has forcibly contacted the second locking region 234, thereby forming an interference fit between the fastening collar 102 and the pin 120, retaining the fastening collar 102 on the pin 120 prior to deformation of the fastening collar 102 to install the multi-piece fastener 100. In various non-limiting embodiments, the interference fit can be achieved by applying axial force to the fastening collar 102 with the hand of an operator. The interference fit can enable more efficient installation of the multi-piece fastener 100 and can allow an operator to concentrate on operating the multi-piece fastener installation tool rather than holding the collar 102 on the pin 120. In various non-limiting embodiments, forming an interference fit as described herein can be accomplished in less time than, for example, threading a threaded fastening collar onto a threaded shank of the pin.

Referring to FIG. 3C, as will be understood by those having ordinary skill in the multi-piece fastener art, the jaw of the collet of a multi-piece fastener installation tool (e.g., a fastening collar installation tool) can close around and forcibly contact the pull region 124 of pin 120, thereby engaging the pull region 124. Upon engagement, the collet can apply an axial force to the pull region 124 of the pin 120. The collet can retract into a housing of the multi-piece fastener installation tool, and the pin 120 also moves as the collet retracts due to the contact between the pull region 124 and the collet. As suggested by FIG. 3C, the anvil has forcibly contacted the fastening collar 102 with an axial force greater than an opposed force produced by the interference fit between the fastening collar 102 and the pin 120. The fastening collar 102 has moved along the pin 120 in a direction away from the first pin end 128, urged by the anvil of the fastening collar installation apparatus. The movement of the fastening collar 102 can decrease a gap, if present, between the first layer 344a and the second layer 344b of the structure 144 and forcibly contact the fastening collar 102 with the structure 144.

When the anvil of the multi-piece fastener installation tool produces a predetermined force imparts a sufficient force on the fastening collar 102, the elongate portion 108 can be at least partially deformed responsive to the forcible contact between the anvil and the fastening collar 102. For example, the elongate portion 108 can be swaged onto a generally smooth region, a threaded region, an annular shoulder, and/or a groove on a section of the shank 122 of the pin 102 intermediate the first layer 344a and the first pin end 128.

The deformation of the elongate portion 108 can secure the fastening collar 102 to the pin 120, and thereby secure the multi-piece fastener 100 to at least a portion of the structure 144. In that way, for example, the first layer 344a and second layer 344b of the structure 144 are secured together. After installation of the multi-piece fastener 100 into the structure 144, the fastening collar 102 and the head portion 136 of the pin 120 are applying a clamping force to the structure 144.

As illustrated in FIG. 3C, the pin 120 may not fracture after installation into the structure 144. Alternatively, as illustrated in FIGS. 6C, 7C, and 8C, the pin 120 may fracture after installation into the structure 144 as a result of force applied to the pin 102 by the multi-piece fastener installation tool. For example, the pin 120 may fracture along breakneck groove 640 after installation into the structure 144.

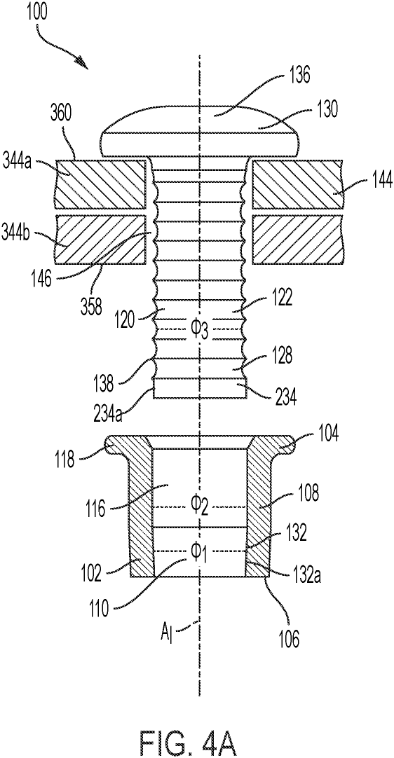

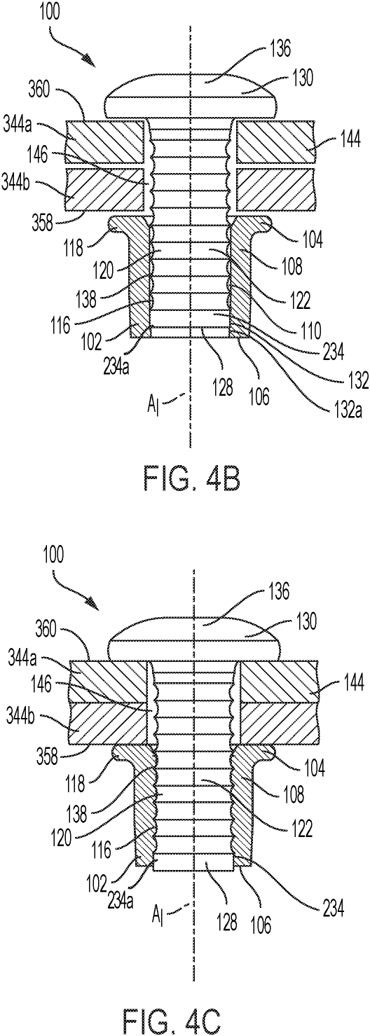

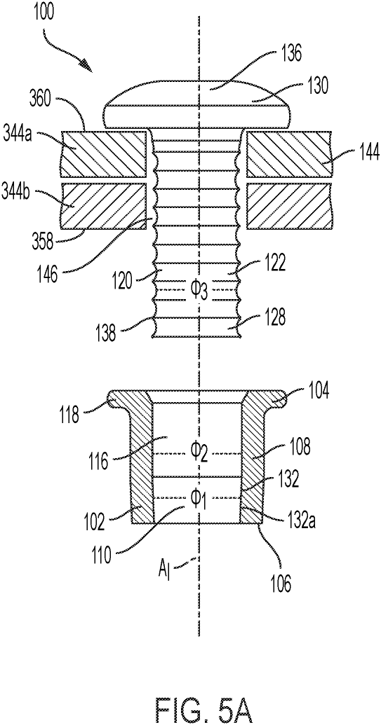

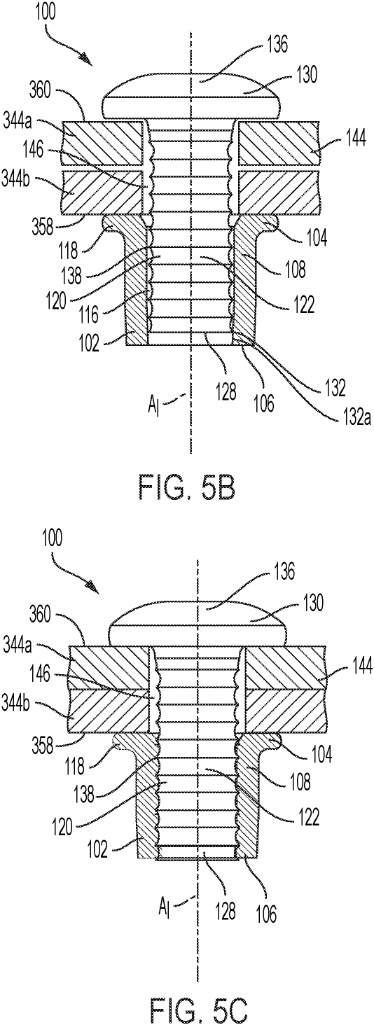

FIGS. 4A-C and 5A-C illustrate steps of an installation sequence comparable to FIGS. 3A-C for certain embodiments of a multi-piece fastener according to the present disclosure. In FIGS. 4B and 5B the fastening collar and the pin of the fastener are retained together by an interference fit prior to deformation of the fastening collar onto the pin (shown in FIGS. 4C and 5C). The pin of each multi-piece fastener shown in FIGS. 4A-C and 5A-C does not comprise a breakneck groove, and a portion of the pin is not fractured during the installation process.

FIGS. 6A-C, 7A-C, and 8A-C also illustrate steps of an installation sequence comparable to FIGS. 3A-C for certain embodiments of a multi-piece fastener according to the present disclosure. In FIGS. 6B, 7B, and 8B the fastening collar and the pin of the fastener are retained together by an interference fit prior to deformation of the fastening collar onto the pin (shown in FIGS. 6C, 7C, 8C). The pin of each multi-piece fastener shown in FIGS. 6A-C, 7A-C, and 8A-C comprises a breakneck groove, and as shown in FIGS. 6C, 7C, and 8C, a portion of the pin is fractured during the installation process.

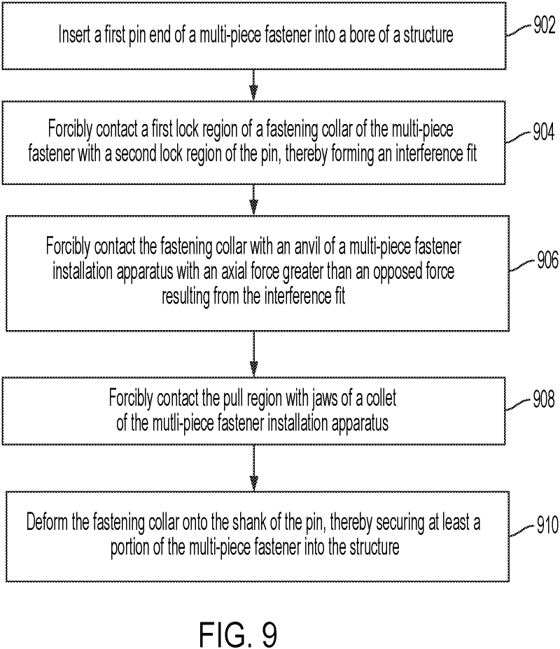

Embodiments of multi-piece fasteners according to the present disclosure can be used in a method for fastening a structure. FIG. 9 illustrates steps of a non-limiting embodiment of such a method. The method illustrated in FIG. 9 can comprise inserting the first pin end 128 of a multi-piece fastener 100 into a bore 146 in a structure 144 (at step 902). After inserting the first pin end 128 into the structure 144, the first lock region 132 of the fastening collar 102 can be forcibly contacted with the second lock region 234 of the pin 120, thereby forming an interference fit between the fastening collar 102 and the pin 120 (at step 904). Subsequent to forming the interference fit, in certain non-limiting embodiments, the fastening collar 102 can be forcibly contacted with an anvil of a multi-piece fastener installation apparatus with an axial force greater than an opposed force resulting from the interference fit. This can move the fastening collar 102 along the pin 120 in a direction away from the first pin end 128 utilizing the anvil of the fastening collar installation apparatus (at step 906). In various non-limiting embodiments, the pull region 124 can be forcibly contacted with jaws of the collet of the multi-piece fastener installation apparatus (at step 908). The fastening collar 102 can be deformed onto the shank 122 of the pin 120, thereby securing at least a portion of the multi-piece fastener 100 in the structure 144 (at step 910).

Various aspects of embodiments of inventions according to the present disclosure include, but are not limited to, the aspects listed in the following numbered clauses.
1. A multi-piece fastener comprising:
   a fastening collar comprising
      a first collar end,
      a second collar end, and
      an inner collar surface extending from the first collar end to the second collar end and comprising a first lock region, wherein the inner collar surface defines a collar cavity; and
   a pin configured to be at least partially received by the collar cavity, the pin comprising
      a first pin end,
      a second pin end, and
      a shank extending intermediate the first pin end and the second pin end,
   wherein the shank comprises a second lock region configured to engage the first lock region to form an interference fit between the fastening collar and the pin when the pin is received in the collar cavity, and wherein the fastening collar is configured to be deformed onto the shank.
2. The multi-piece fastener of clause 1, wherein at least one of the first lock region and the second lock region defines a taper in a range of 0.5 degrees to 15 degrees relative to a longitudinal axis of the fastening collar.
3. The multi-piece fastener of any of clauses 1-2, wherein at least one of the first lock region and the second lock region comprises a frustoconical shape.
4. The multi-piece fastener of any of clauses 1-3, wherein at least one of the first lock region and the second lock region defines a curve relative to a longitudinal axis of the fastening collar.
5. The multi-piece fastener of any of clauses 1-4, wherein a dimension of the collar cavity decreases along the first lock region in an axial direction towards the second collar end.
6. The multi-piece fastener of any of clauses 1-5, wherein a diameter of the collar cavity in the first lock region is less than a diameter of the collar cavity adjacent to the first lock region.
7. The multi-piece fastener of any of clauses 1-6, wherein a diameter of the shank decreases in an axial direction towards the first pin end.
8. The multi-piece fastener of any of clauses 1-6, wherein the second lock region is substantially cylindrical.
9. The multi-piece fastener of any of clauses 1-8, wherein the first pin end comprises a pull-region.
10. The multi-piece fastener of any of clauses 1-9, wherein the shank comprises at least one of a generally smooth region, an annular shoulder, a groove, and a threaded region.
11. The multi-piece fastener of any of clauses 1-10, wherein the multi-piece fastener is configured to be installed in a bore in a structure and wherein the structure is configured as at least one of an aerospace part or component, an automotive part or component, a transportation part or component, and a building and construction part or component.
12. The multi-piece fastener of any of clauses 1-11, wherein a diameter of the shank is in a range of 0.06 inches to 4 inches.
13. A lockbolt comprising the multi-piece fastener of any of clauses 1-12.
14. A method for fastening, the method comprising:
   inserting a first pin end of a multi-piece fastener of any of clauses 1-13 into a bore in a structure; and
   forcibly contacting the first lock region with the second lock region thereby forming an interference fit between the fastening collar and the pin.
15. A method for fastening, the method comprising:
   inserting a first pin end of a multi-piece fastener into a bore in a structure, the multi-piece fastener comprising
      a fastening collar comprising
         a first collar end,
         a second collar end, and
         an inner collar surface extending from the first collar end to the second collar end and comprising a first lock region, wherein the inner collar surface defines a collar cavity;
      a pin comprising
         a first pin end,
         the second pin end, and
         a shank extending intermediate the first pin end and the second pin end, wherein the shank comprises a second lock region,
   passing at least a portion of the first pin end into the collar cavity; and
   forcibly contacting the first lock region with the second lock region thereby forming an interference fit between the fastening collar and the pin.
16. The method of any of clauses 14-15, further comprising:
   subsequent to forming the interference fit, forcibly contacting the fastening collar with an anvil of a fastening collar installation apparatus with an axial force greater than an opposed force resulting from the interference fit, and moving the fastening collar along the pin in a direction away from the first pin end utilizing the anvil of the fastening collar installation apparatus.
17. The method of clause 16, wherein the first pin end comprises a pull region and the method further comprises:
   forcibly contacting the pull region with jaws of a collet of the fastening collar installation apparatus.
18. The method of clause 17, further comprising deforming the fastening collar onto the shank of the pin with an anvil of the fastening collar installation apparatus and securing at least a portion of the multi-piece fastener in the structure.
19. The method of any of clauses 15-18, wherein a dimension of the collar cavity decreases along the first lock region in an axial direction towards the second collar end.
20. The method of any of clauses 15-19, wherein a diameter of the collar cavity in the first lock region is less than a diameter of the collar cavity adjacent to the first lock region.
21. The method of any of clauses 15-20, wherein a diameter of the shank decreases in an axial direction towards the first pin end.

One skilled in the art will recognize that the herein described fasteners, structures, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A multi-piece fastener comprising:
a fastening collar comprising
a first collar end,
a second collar end, and
an inner collar surface extending from the first collar end to the second collar end and comprising a first lock region, wherein the inner collar surface defines a collar cavity; and
a pin configured to be at least partially received by the collar cavity, the pin comprising
a first pin end,
a second pin end, and
a shank extending intermediate the first pin end and the second pin end, wherein the shank comprises a second lock region configured to engage the first lock region to form an interference fit between the fastening collar and the pin when the pin is received in the collar cavity, and wherein the fastening collar is configured to be deformed onto the shank.

2. The multi-piece fastener of claim 1, wherein at least one of the first lock region and the second lock region defines a taper in a range of 0.5 degrees to 15 degrees relative to a longitudinal axis of the fastening collar.

3. The multi-piece fastener of claim 1, wherein at least one of the first lock region and the second lock region comprises a frustoconical shape.

4. The multi-piece fastener of claim 1, wherein at least one of the first lock region and the second lock region defines a curve relative to a longitudinal axis of the fastening collar.

5. The multi-piece fastener of claim 1, wherein a dimension of the collar cavity decreases along the first lock region in an axial direction towards the second collar end.

6. The multi-piece fastener of claim 1, wherein a diameter of the collar cavity in the first lock region is less than a diameter of the collar cavity adjacent to the first lock region.

7. The multi-piece fastener of claim 1, wherein a diameter of the shank decreases in an axial direction towards the first pin end.

8. The multi-piece fastener of claim 1, wherein the second lock region is substantially cylindrical.

9. The multi-piece fastener of claim 1, wherein the first pin end comprises a pull-region.

10. The multi-piece fastener of claim 1, wherein the shank comprises at least one of a generally smooth region, an annular shoulder, a groove, and a threaded region.

11. The multi-piece fastener of claim 1, wherein the multi-piece fastener is configured to be installed in a bore in a structure and wherein the structure is configured as at least one of an aerospace part or component, an automotive part or component, a transportation part or component, and a building and construction part or component.

12. The multi-piece fastener of claim 1, wherein a diameter of the shank is in a range of 0.06 inches to 4 inches.

13. A lockbolt comprising the multi-piece fastener of claim 1.

14. A method for fastening, the method comprising:
inserting a first pin end of a multi-piece fastener into a bore in a structure, the multi-piece fastener comprising
a fastening collar comprising
a first collar end,
a second collar end, and
an inner collar surface extending from the first collar end to the second collar end and comprising a first lock region, wherein the inner collar surface defines a collar cavity;
a pin comprising
a first pin end,
the second pin end, and
a shank extending intermediate the first pin end and the second pin end, wherein the shank comprises a second lock region,
passing at least a portion of the first pin end into the collar cavity; and
forcibly contacting the first lock region with the second lock region thereby forming an interference fit between the fastening collar and the pin.

15. The method of claim 14, further comprising:
subsequent to forming the interference fit, forcibly contacting the fastening collar with an anvil of a fastening collar installation apparatus with an axial force greater than an opposed force resulting from the interference fit, and moving the fastening collar along the pin in a direction away from the first pin end utilizing the anvil of the fastening collar installation apparatus.

16. The method of claim 15, wherein the first pin end comprises a pull region and the method further comprises:
forcibly contacting the pull region with jaws of a collet of the fastening collar installation apparatus.

17. The method of claim 16, further comprising deforming the fastening collar onto the shank of the pin with an anvil of the fastening collar installation apparatus and securing at least a portion of the multi-piece fastener in the structure.

18. The method of claim 17, wherein a dimension of the collar cavity decreases along the first lock region in an axial direction towards the second collar end.

19. The method of claim 14, wherein a diameter of the collar cavity in the first lock region is less than a diameter of the collar cavity adjacent to the first lock region.

20. The method of claim 14, wherein a diameter of the shank decreases in an axial direction towards the first pin end.
